(19) United States
(12) Patent Application Publication
(10) Pub. No.: US 2025/0070625 A1
(43) Pub. Date: Feb. 27, 2025

(54) MOTOR

(71) Applicant: LG INNOTEK CO., LTD., Seoul (KR)

(72) Inventor: Jung Soo YANG, Seoul (KR)

(21) Appl. No.: 18/724,445

(22) PCT Filed: Dec. 7, 2022
(86) PCT No.: PCT/KR2022/019776

§ 371 Date: Jun. 26, 2024

(30) Foreign Application Priority Data
Dec. 27, 2021 (KR) 10-2021-0188723

(51) Int. Cl. H02K 11/30

(52) U.S. Cl. CPC H02K 11/30; H02K 2203/09; H02K 2211/03

(57) ABSTRACT

A motor according to an embodiment disclosed herein comprises: a stator; a rotor disposed inside the stator; a shaft coupled to the rotor; a bus bar disposed on the stator; boards in which a plurality of holes are formed so that the ends of terminals of the bus bar are disposed therein; and soldering members disposed in the holes so that the terminals and the boards are electrically connected. The boards comprise: a body in which the holes are formed; wiring patterns formed around the holes; and a plurality of passes extending from the wiring patterns to the holes, wherein a non-conductive region is disposed between the passes. Accordingly, the bus bar in the motor can be made compact by using the plurality of terminals which maintain a certain spacing between one another even when some are disposed on the same plane. In addition, the motor forms a heat dissipation structure through the passes formed in each of the plurality of boards, and thus can minimize the rate of defects due to soldering.

### TECHNICAL FIELD

The present invention relates to a motor.

### BACKGROUND ART

A motor is an apparatus that changes electrical energy to rotation energy using a force received by a conductor in an electric field. Recently, as the usage of the motor increases, functions of the motor become important. Particularly, as more electric devices are used in vehicles, demands for motors applied to steering systems, braking systems, machinery systems, and the like greatly increase.

The motor may include a housing, a cover disposed on an opening of the housing, a shaft, a rotor disposed on an outer circumferential surface of the shaft, a stator disposed to correspond to the rotor, a busbar disposed on the stator, a substrate connected to a terminal of the busbar, and the like. In this case, the stator induces an electrical interaction with the rotor to induce the rotation of the rotor. Accordingly, the shaft coupled to the rotor also rotates.

An end portion of the terminal and the substrate may be electrically connected through a soldering method.

For example, the end portion may be disposed to pass through a hole formed in the substrate, and the terminal and the substrate may be electrically connected by melting a soldering member in the hole.

However, there is a problem of increasing a soldering failure rate because a fillet is not properly formed at a lower side of the hole due to a problem of heat generated during soldering. In this case, an upper portion of the hole may be a portion on which the soldering member is supplied, and the lower portion may be a portion opposite to the upper portion.

Therefore, motors in which the soldering failure can be minimized are being required.

### DISCLOSURE

### Technical Problem

The present invention is directed to minimizing the rate of failures due to soldering by forming a heat transfer structure using a path formed each of a plurality of substrates.

Objectives to be achieved by embodiments are not limited to the above-described objectives, and other objectives, which are not described above, may be clearly understood by those skilled in the art through the following specification.

### Technical Solution

One aspect of the present invention provides a motor including a stator, a rotor disposed inside the stator, a shaft coupled to the rotor, busbar disposed on the stator, a substrate in which a plurality of holes are formed so that end portions of terminals of the busbar are disposed therein, and a soldering member disposed in the hole to electrically connect the terminal and the substrate, wherein the substrate includes a body in which the hole is formed, a line pattern formed around the hole, and a plurality of paths extending from the line pattern to the hole, and a non-conductive region is disposed between the paths.

Another aspect of the present invention provides a motor including a stator, a rotor disposed inside the stator, a shaft coupled to the rotor, busbar disposed on the stator, a substrate in which a plurality of holes are formed so that end portions of terminals of the busbar are disposed therein, and a soldering member disposed in the hole to electrically connect the terminal and the substrate, wherein the substrate includes a first substrate and a second substrate, the first substrate includes a first body in which a first hole is formed, a first line pattern formed around and spaced apart from the first hole, and a plurality of first paths extending from the first line pattern to the first hole, and the second substrate includes a second body in which a second hole is formed, a second line pattern disposed around and spaced apart from the second hole, and a plurality of second paths extending from the second line pattern to the second hole.

### Advantageous Effects

According to an embodiment, the rate of failures due to soldering can be minimized by forming a heat transfer structure using a path formed in each of a plurality of substrates.

Various useful advantages and effects of the embodiment are not limited to the above-described contents and can be more easily understood in the detailed description of specific embodiments.

### DESCRIPTION OF DRAWINGS

FIG. 1 is a perspective view illustrating a motor according to an embodiment.

FIG. 2 is a cross-sectional view illustrating the motor according to the embodiment.

FIG. 3 is a bottom view illustrating a terminal, a substrate, and a soldering member disposed in the motor according to the embodiment.

FIG. 4 is an enlarged view illustrating portion A of FIG. 3.

FIG. 5 is a view illustrating arrangement relationships between the terminal, the substrate, and the soldering member disposed in the motor according to the embodiment.

FIG. 6 is an exploded perspective view illustrating a first substrate and a second substrate of the substrate disposed in the motor according to the embodiment.

FIG. 7 is a plan view illustrating the first substrate of the substrate disposed in the motor according to the embodiment.

FIG. 8 is a plan view illustrating the second substrate of the substrate disposed in the motor according to the embodiment.

FIG. 9 is a view illustrating an arrangement relationship between a first path of the first substrate and a second path of the second substrate disposed in the motor according to the embodiment.

### MODES OF THE INVENTION

Hereinafter, embodiments will be described with reference to the accompanying drawings. However, the present invention is not limited to some embodiments which will be described and may be implemented in a variety of different forms, and one or more components of the embodiments may be selectively combined, substituted, and used.

In addition, when a first component is described as being formed or disposed “on” or “under” a second component, such a description includes both a case in which the two components are formed or disposed in direct contact with each other and a case in which one or more other components are interposed between the two components. In addition, when the first component is described as being formed “on or under” the second component, such a description may include a case in which the first component is formed at an upper side or a lower side with respect to the second component.

Hereinafter, when the embodiments are described in detail with reference to the accompanying drawings, components that are the same or correspond to each other will be denoted by the same or corresponding reference numerals in all drawings, and redundant descriptions will be omitted.

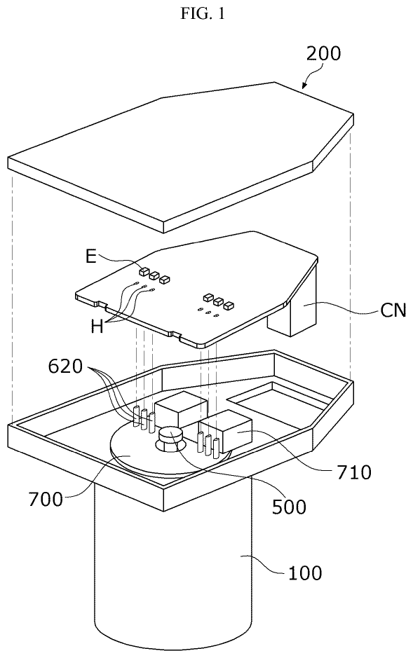

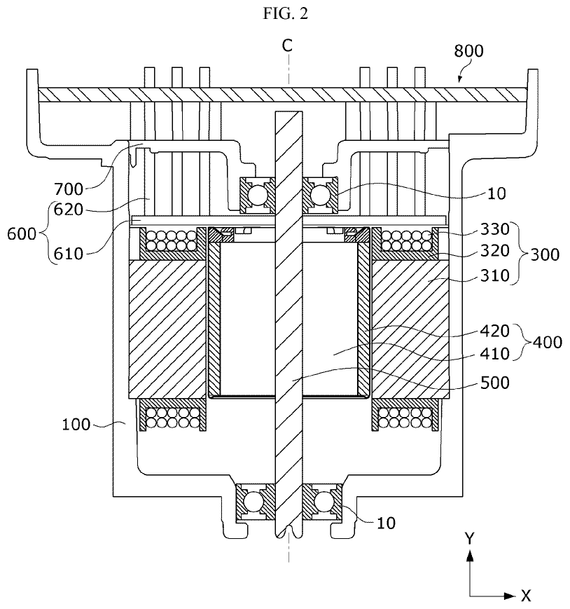

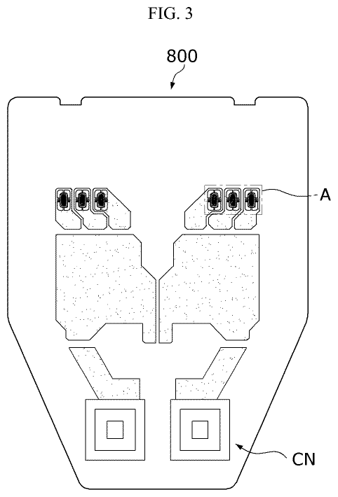

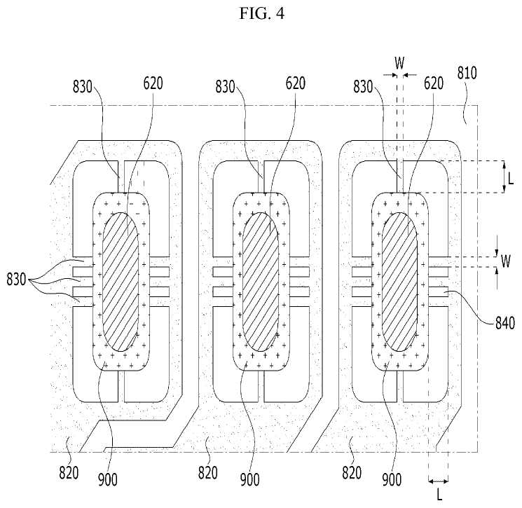

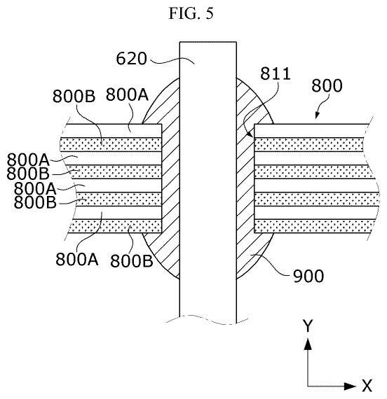

FIG. 1 is a perspective view illustrating a motor according to an embodiment, and FIG. 2 is a cross-sectional view illustrating the motor according to the embodiment. FIG. 3 is a bottom view illustrating a terminal, a substrate, and a soldering member disposed in the motor according to the embodiment, and FIG. 4 is an enlarged view illustrating portion A of FIG. 3. FIG. 5 is a view illustrating arrangement relationships between the terminal, the substrate, and the soldering member disposed in the motor according to the embodiment.

In this case, an X direction illustrated in FIG. 2 may be a radial direction, and a Y direction may be an axial direction. In addition, the axial direction and the radial direction may be perpendicular to each other. In addition, a direction along a circle having a radius in the radial direction around an axial center may be a circumferential direction. In addition, a reference symbol “C” illustrated in FIG. 2 may be a rotation center (axial center).

Referring to FIGS. 1 to 5, the motor according to the embodiment may include a housing 100 in which an opening is formed at one side, a cover 200 disposed to cover the opening, a stator 300 disposed in the housing 100, a rotor 400 disposed inside the stator 300, a shaft 500 coupled to the rotor 400, a busbar 600 disposed on the stator 300, a bracket 700 disposed on the busbar 600, a substrate 800 disposed on the bracket 700, and a soldering member 900 electrically connecting a terminal 620 of the busbar 600 and the substrate 800. In this case, the term “inward” is a direction toward a rotation center C of the motor in the radial direction, and the term “outward” is a direction opposite to “inward.”

The housing 100 and the cover 200 may form an exterior of the motor. In addition, an accommodation space may be formed inside the housing 100 and the cover 200 by coupling the housing 100 and the cover 200. Accordingly, the stator 300, the rotor 400, the shaft 500, the busbar 600, and the like may be disposed in the accommodation space.

In this case, the shaft 500 is rotatably disposed in the accommodation space. Accordingly, the motor may further include bearings 10 disposed on an upper portion and a lower portion of the shaft 500. In this case, the bearing 10 disposed on the housing 100 may be referred to as a first bearing or lower bearing, and the bearing 10 disposed on the bracket 700 may be referred to as a second bearing or upper bearing.

The housing 100 may be formed in a tube shape. In addition, the housing 100 may accommodate the stator 300, the rotor 400, and the like therein. In this case, the shape or a material of the housing 100 may be variously changed. For example, the housing 100 may be formed of a metal such as aluminum which has resistance to high temperature.

The cover 200 may be disposed on an open surface of the housing 100, that is, on an upper portion of the housing 100 to cover the opening of the housing 100. In this case, a shape or a material of the cover 200 may be variously changed. For example, the cover 200 may be formed of a metal which has resistance to high temperature.

Referring to FIG. 2, the stator 300 may include a stator core 310, an insulator 320 disposed on the stator core 310, and a coil 330 wound around the insulator 320.

The coil 330, which generates a rotating magnetic field, may be wound around the stator core 310. In this case, the stator core 310 may be formed as one core or formed by coupling a plurality of divided cores.

In addition, the stator core 310 may be formed in a form in which a plurality of thin steel plates are stacked on each other, but is not necessarily limited thereto. For example, the stator core 310 may be formed as one single part.

The stator core 310 may include a yoke (not shown) formed in a cylindrical shape and a plurality of teeth (not shown) protruding from the yoke in the radial direction.

The plurality of teeth may be disposed to be spaced apart from each other in a circumferential direction of the yoke. Accordingly, a slot, which is a space in which the coil 330 is wound, may be formed between the teeth.

Meanwhile, the tooth of the stator 300 and the rotor 400 may be disposed to form an air gap therebetween. In this case, the air gap may be a distance between the tooth and a magnet 420 in the radial direction.

The insulator 320 insulates the stator core 310 from the coil 330. Accordingly, the insulator 320 may be disposed between the stator core 310 and the coil 330.

Accordingly, the coil 330 may be wound around the stator core 310 on which the insulator 320 is disposed.

The rotor 400 is rotated through an electrical interaction with the stator 300. In this case, the rotor 400 may be rotatably disposed around the stator 300.

Referring to FIG. 2, the rotor 400 may include a rotor core 410 and a plurality of magnets 420 disposed outside the rotor core 410. That is, the rotor 400 may be formed in a surface permanent magnet (SPM) type in which the magnets 420 are attached to a surface of the rotor core 410. In this case, the magnets 420 may be disposed to be spaced a predetermined distance from the rotor core 410 based on the center C in the circumferential direction.

In addition, the rotor 400 may further include a can for protecting the rotor core 410 and the magnets 420. In this case, the can may be disposed to cover the rotor core 410 coupled to the magnets 420.

The rotor core 410 may be formed in a form in which a plurality of thin steel plates are stacked on each other or formed as a tube-shaped single part.

In addition, the rotor core 410 may be formed in a cylindrical shape, and a hole coupled to the shaft 500 may be formed at the center C.

The magnets 420 and the coil 330 wound around the stator core 310 of the stator 300 generate a rotating magnetic field. Accordingly, the rotor 400 is rotated due to an electrical interaction between the coil 330 and the magnets 420, and the shaft 500 is rotated in conjunction with the rotation of the rotor 400 to generate a driving force of the motor. In this case, the magnets 420 of the rotor 400 may be referred to as drive magnets.

The plurality of magnets 420 may be disposed on an outer circumferential surface of the rotor core 410 to be spaced apart from each other in the circumferential direction.

The shaft 500 may be disposed in the housing 100 to be rotatable due to the bearings 10. In addition, the shaft 500 may rotate in conjunction with the rotation of the rotor 400 together therewith.

In addition, the shaft 500 may be coupled to the hole formed at a center of the rotor core 410 through a press-fitting method.

The busbar 600 may be disposed on the stator 300.

In addition, the busbar 600 may be electrically connected to the coil 330 of the stator 300. In addition, the busbar 600 may be electrically connected to the substrate 800 through a hole and the like formed in the bracket 700.

Referring to FIG. 2, the busbar 600 may include a busbar holder 610 and a plurality of terminals 620 disposed on the busbar holder 610. In this case, the busbar holder 610 may be referred to as a busbar body.

The busbar holder 610 may be formed in a plate shape having a predetermined axial thickness.

In addition, the busbar holder 610 may be formed in an annular shape in which a hole is formed to pass through a center thereof in the axial direction.

In addition, the busbar holder 610 may be formed of a synthetic resin material such as a resin. In addition, the busbar holder 610 may be formed through an injection molding method. For example, the busbar 600 may be formed in a method of injecting a molding material onto the plurality of terminals 620 to form the busbar holder 610.

That is, the busbar holder 610 may be a mold part formed by injection-molding an insulating material. In addition, when the busbar holder 610 is injection-molded, since the molding material fills between the terminals 620, the insulation between the terminals 620 can be secured. Accordingly, the busbar holder 610 can allow the plurality of terminals 620 to be physically and electrically separated from each other.

The terminal 620 may be formed of a metal material to electrically connect the coil 330 of the stator 300 and an external power source. For example, one side of the terminal 620 may be connected to the coil 330, and the other side thereof may be connected to the substrate 800. Specifically, an end portion of the terminal 620 may be electrically connected to the substrate 800 through a soldering method. In addition, a line pattern 820 formed on the substrate 800 may be electrically connected to a connector part CN. In this case, a fillet welding method may be used as the soldering method.

Accordingly, the terminal 620 may supply power to the coil 330. For example, the plurality of terminals 620 may supply power with one of U-, V-, and W-phases to the coil 330.

The bracket 700 may be disposed to cover the opening formed in an accommodation part of the housing 100. In this case, the stator 300, the rotor 400, the shaft 500, the busbar 600, and the like may be disposed in the accommodation part.

In addition, the bracket 700 may include a plurality of holes to expose end portions of the terminals 620 and an end portion of the shaft 500.

In addition, the bracket 700 may include a protruding part 710 formed to support the substrate 800.

In addition, the bearing 10 may be formed on the bracket 700. Accordingly, the bracket 700 may rotatably support the shaft 500.

The substrate 800 may be disposed on the bracket 700. In addition, a plurality of elements E and the connector part CN may be disposed on the substrate 800. In this case, an external power source such as a connector may be connected to the connector part CN. In addition, the substrate 800 may be a printed circuit board (PCB).

The substrate 800 may include a body 810 in which a plurality of holes H are formed, line patterns 820 formed around the holes H, a plurality of paths 830 extending from the line patterns 820 to the holes H, and non-conductive regions 840 disposed between the paths 830.

In this case, the line pattern 820 and the path 830 may be integrally formed. In addition, the terminal 620 and the path 830 may be electrically connected through the soldering member 900.

The body 810 may be formed in a plate shape. In addition, the body 810 may be formed of an insulating material.

The hole H may be formed to pass through the body 810 in the axial direction. In addition, the end portion of the terminal 620 may be disposed to pass through the hole H. In this case, the terminal 620 may be disposed to be spaced apart from an inner surface 811 forming the hole H. Accordingly, the soldering member 900 may be disposed between the terminal 620 and the hole H.

The line pattern 820 and the path 830 may be formed on the body 810 through a printing method. Accordingly, the line pattern 820 and the path 830 may be formed on one surface of the body 810. In this case, the line pattern 820 and the path 830 may be formed of a conductive material such as a metal.

A plurality of patterns electrically connected to the elements E and the connector part CN may be formed on the body 810.

The line pattern 820 may be one of the plurality of patterns and may be a pattern disposed adjacent to the hole H. Here, the term “adjacent” may mean “separately disposed to have a predetermined distance.”

The line pattern 820 may be formed around the hole H and disposed to be spaced apart from the hole H. In this case, since the plurality of holes H may be formed to be spaced apart from each other, a plurality of line patterns 820 may also be formed to be spaced apart from each other.

The path 830 is disposed between the line pattern 820 and the soldering member 900 and electrically connects the line pattern 820 and the soldering member 900.

In this case, the plurality of paths 830 may be disposed around the hole H to be spaced apart from each other. Accordingly, heat generated during soldering may be transferred through the paths 830.

In addition, for uniform heat transfer, the plurality of paths 830 may be formed to have the same size. For example, widths W of the plurality of paths 830 may be the same. In addition, lengths L of the plurality of paths 830 may be the same.

The non-conductive region 840 may be a region which is not printed on the body 810. That is, when the line pattern 820 and the path 830 are formed through the printing method, the non-conductive region 840 may also be formed. Accordingly, the non-conductive region 840 may be one region of the body 810 formed of the insulating material.

In addition, the non-conductive region 840 together with the path 830 may be disposed between the line pattern 820 and the hole H. In this case, since the non-conductive region 840 has a lower thermal conductivity than the path 830, most heat generated during soldering may be transferred through the path 830.

Referring to FIG. 5, the substrate 800 may be formed by stacking a plurality of unit substrates. Accordingly, the substrate 800 may be a multilayered substrate.

Accordingly, the substrate 800 may include first substrates 800A and second substrates 800B and may be formed by alternately stacking the first substrates 800A and the second substrates 800B.

As a heat transfer structure using the path is formed in each of the plurality of first substrates 800A and second substrates 800B, uniform heat may be dissipated and thus a fillet may be formed down to a lower side of the hole H. Accordingly, a soldering failure can be prevented or a soldering failure rate can be minimized in the motor.

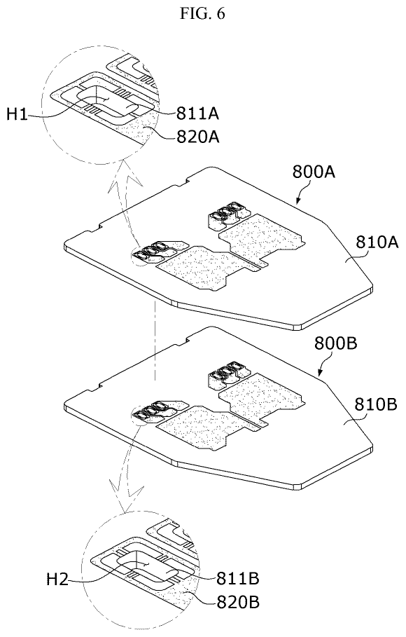

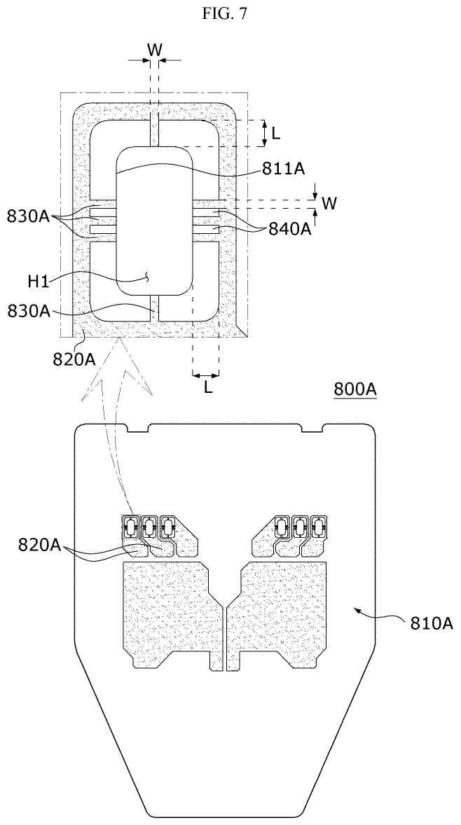

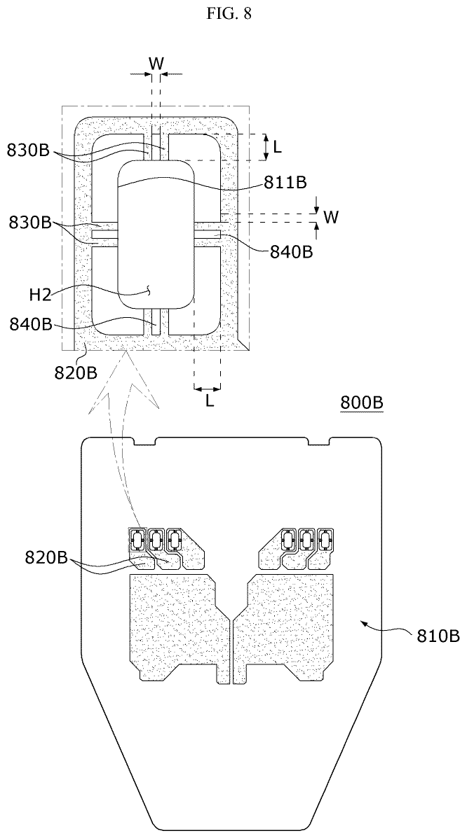

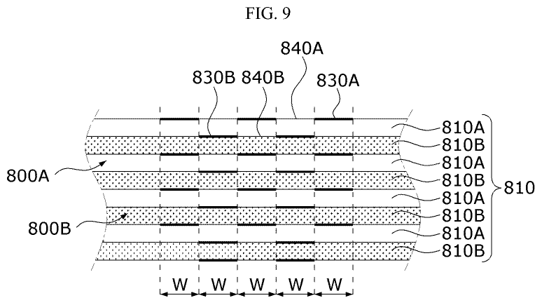

FIG. 6 is an exploded perspective view illustrating the first substrate and the second substrate of the substrate disposed in the motor according to the embodiment, and FIG. 7 is a plan view illustrating the first substrate of the substrate disposed in the motor according to the embodiment. FIG. 8 is a plan view illustrating the second substrate of the substrate disposed in the motor according to the embodiment, and FIG. 9 is a view illustrating an arrangement relationship between a first path of the first substrate and a second path of the second substrate disposed in the motor according to the embodiment. In this case, FIG. 9 may show one surface of inner surfaces 811 forming the holes H in the body 810.

One surface of the first substrate 800A and one surface of the second substrate 800B may be disposed in contact with each other in a stacking direction. In this case, “the stacking direction” may be a direction in which the first substrate 800A and the second substrate 800B are stacked and may be the axial direction. In addition, since the hole H of the substrate 800 is formed by stacking the first substrate 800A and the second substrate 800B, the stacking direction may be referred to as a through direction.

In this case, since a line pattern and a path are also formed on the second substrate 800B disposed between the first substrates 800A, heat generated during soldering may be transferred through the line pattern and the path of the second substrate 800B. In addition, since a line pattern and a path are also formed on the first substrate 800B disposed between the second substrates 800B, heat generated during soldering may be transferred through the line pattern and the path of the first substrate 800B. Accordingly, the rate of failures due to soldering can be minimized in the motor.

Referring to FIG. 7, the first substrate 800A may include a first body 810A in which a first hole H1 is formed, a first line pattern 820A formed around and spaced apart from the first hole H1, a plurality of first paths 830A extending from the first line pattern 820A to the first hole H1, and first non-conductive regions 840A disposed between the first paths 830A. In this case, the first line pattern 820A and the first paths 830A may be integrally formed.

The first body 810A may be formed in a plate shape. In addition, the first body 810A may be formed of an insulating material.

The first hole H1 may be formed to pass through the first body 810A in the axial direction. In addition, the end portion of the terminal 620 may be disposed to pass through the first hole H1. In this case, the terminal 620 may be disposed to be spaced apart from a first inner surface 811A forming the first hole H1. Accordingly, the soldering member 900 may be disposed between the terminal 620 and the first hole H1.

In addition, the first hole H1 may be formed in a polygonal shape, and the first paths 830A may be disposed to correspond to surfaces of the polygonal shape. In this case, the number of first paths 830 disposed to correspond to each surface of the first hole H1 may be an odd number. In addition, a total number of first holes H1 may be two times the number of surfaces of the polygonal shape.

As illustrated in FIG. 7, the first hole H1 may be formed in a quadrangular shape, and the number of first paths 830A disposed to correspond to each of the surfaces of the first hole H1 may be the odd number. For example, the number of first paths 830A disposed to correspond to one surface of the first hole H1 may be one, and the number of first paths 830A disposed to correspond to the other surface of the first hole H1 may be three.

In addition, since the number of surfaces of the first hole H1 is four, a total number of first paths 830A may be eight.

The first line pattern 820A and the first path 830A may be formed on one surface of the first body 810A. In this case, the first line pattern 820A and the first path 830A may be formed of a conductive material such as a metal material.

The first line pattern 820A may be one of a plurality of patterns and may be a pattern disposed adjacent to the first hole H1.

The first line pattern 820A may be formed around the first hole H1 and disposed to be spaced apart from the first hole H1. In this case, since a plurality of first holes H1 may be formed in the first body 810A to be spaced apart from each other, a plurality of first line patterns 820A may be formed to be spaced apart from each other.

The first path 830A is disposed between the first line pattern 820A and the soldering member 900 to connect the first line pattern 820A and the soldering member 900.

In this case, the plurality of first paths 830A may be disposed around the first hole H1 to be spaced apart from each other. Accordingly, heat generated during soldering may be transferred through the first paths 830A.

In addition, for uniform heat transfer, the plurality of first paths 830A may be formed to have the same sizes. For example, widths W of the plurality of first paths 830A may be the same. In addition, lengths L of the plurality of first path 830A may be the same.

The first non-conductive region 840A may be a region which is not printed on the first body 810A. That is, when the first line pattern 820A and the first path 830A are formed through a printing method, the first non-conductive region 840A may also be formed. Accordingly, the first non-conductive region 840A may be one region of the first body 810A formed of the insulating material.

In addition, the first non-conductive region 840A together with the first path 830A may be disposed between the first line pattern 820A and the first hole H1. In this case, since the first non-conductive region 840A have a relatively lower thermal conductivity than the first path 830A, most heat generated during soldering may be transferred through the first path 830A.

Referring to FIG. 8, the second substrate 800B may include a second body 810B in which a second hole H2 is formed, a second line pattern 820B formed around and spaced apart from the second hole H2, a plurality of second paths 830B extending from the second line pattern 820B to the second hole H2, and a second non-conductive region 840B disposed between the second paths 830B. Here, the second line pattern 820B and the second path 830B may be integrally formed.

The second body 810B may be formed in a plate shape. In addition, the second body 810B may be formed of an insulating material. In this case, the second body 810B may be formed to have the same size as the first body 810A.

The second hole H2 may be formed to pass through the second body 810B in the axial direction. In addition, the end portion of the terminal 620 may be disposed to pass through the second hole H2. In this case, the terminal 620 may be disposed to be spaced apart from the first inner surface 811A forming the second hole H2. Accordingly, the soldering member 900 may be disposed between the terminal 620 and the second hole H2.

In addition, the second hole H2 may be formed in the same shape as the first hole H2. In addition, when the first substrate 800A and the second substrate 800B are stacked, the first hole H1 and the second hole H2 forms the hole H of the substrate 800.

In addition, the second hole H2 may be formed in a polygonal shape, and the second paths 830B may be disposed to correspond to surfaces of the polygonal shape. In this case, the number of second paths 830B disposed to correspond to each of the surfaces of the second hole H2 may be an even number. In addition, a total number of second holes H2 may be two times the number of surfaces of the polygonal shape.

As illustrated in FIG. 8, the second hole H2 may be formed in a quadrangular shape, and the numbers of second paths 830B disposed to correspond to the surfaces of the second hole H2 may be the even numbers. For example, the number of second paths 830B disposed to correspond to one surface of the second hole H2 may be two.

In addition, since the number of surfaces of the second hole H2 is four, a total number of second paths 830B may be eight.

The second line pattern 820B and the second path 830B may be formed on one surface of the second body 810B. In this case, the second line pattern 820B and the second path 830B may be formed of a conductive material such as a metal material.

The second line pattern 820B may be one of a plurality of patterns and may be a pattern disposed adjacent to the second hole H2.

The second line pattern 820B may be formed around the second hole H2 and disposed to be spaced apart from the second hole H2. In this case, since a plurality of second holes H2 may be formed in the second body 810B to be spaced apart from each other, a plurality of second line patterns 820B may also be formed to be spaced apart from each other.

The second path 830B is disposed between the second line pattern 820B and the soldering member 900 to connect the second line pattern 820B and the soldering member 900.

In this case, the plurality of second paths 830B may be disposed around the second hole H2 to be spaced apart from each other. Accordingly, heat generated during soldering may be transferred through the second paths 830B.

In addition, for uniform heat transfer, sizes and the number of plurality of second paths 830B may be the same as those of the first paths 830A. For example, widths W of the plurality of second paths 830B may be the same. In addition, lengths L of the plurality of second paths 830B may be the same.

The second non-conductive region 840B may be a region which is not printed in the second body 810B. That is, when the second line pattern 820B and the second path 830B are formed through a printing method, the second non-conductive region 840B may also be formed. Accordingly, the second non-conductive region 840B may be one region of the second body 810B formed in the insulating material.

In addition, the second non-conductive region 840B together with the second path 830B may be disposed between the second line pattern 820B and the second hole H2. In this case, since the second non-conductive region 840B has a relatively lower thermal conductivity than the second path 830B, most heat generated during soldering can be transferred through the second path 830B.

Hereinafter, an arrangement relationship between the first paths 830A and the second paths 830B will be described.

As illustrated in FIG. 9, the first paths 830A of the first substrate 800A and the second paths 830B of the second substrate 800B may be alternately disposed in the stacking direction. For example, the first paths 830A of the first substrate 800A and the second paths 830B of the second substrate 800B may be disposed in a zigzag manner.

In addition, the first path 830A of the first substrate 800A and the second path 830B of the second substrate 800B do not overlap in the stacking direction.

In addition, the first path 830A of the first substrate 800A may be disposed to overlap the second non-conductive region 840B of the second substrate 800B. Further, the second path 830B of the second substrate 800B may be disposed to overlap the first non-conductive region 840A of the first substrate 800A.

In this case, in the case of the second substrate 800B disposed at a lowermost end of the substrate 800, the second paths 830B may be disposed on one surface and the other surface of the second body 810B.

The soldering member 900 may fill the hole H. Accordingly, the soldering member 900 may electrically connect the terminal 620 and the path 830.

Heat generated during soldering may be transferred through the paths 830A and 830B formed on the first substrate 800A and the second substrate 800B, respectively. Accordingly, since the fillet is formed down to the lower side of the hole H during soldering, a soldering failure rate can be minimized.

The motor according to the embodiments can be used for various devices for vehicles, home appliances, or the like.

While the present invention has been described above with reference to exemplary embodiments, it may be understood by those skilled in the art that various modifications and changes of the present invention may be made within a range not departing from the spirit and scope of the present invention defined by the appended claims.

### REFERENCE NUMERALS

1: MOTOR, 100: HOUSING, 200: COVER, 300: STATOR, 400: ROTOR, 500: SHAFT, 600: BUSBAR, 7700: BRACKET, 800: SUBSTRATE, 810: BODY, 820: LINE PATTERN, 830: PATH, 840: NON-CONDUCTIVE REGION, 800A: FIRST SUBSTRATE, 800B: SECOND SUBSTRATE, 900: SOLDERING MEMBER

1. A motor comprising:
a stator;
a rotor disposed inside the stator;
a shaft coupled to the rotor;
busbar disposed on the stator;
a substrate in which a plurality of holes are formed and having end portions of terminals of the busbar disposed therein, respectively; and
a soldering member disposed in each hole to electrically connect each terminal and the substrate,
wherein the substrate includes a body in which each hole is formed, a line pattern formed around each hole, and a plurality of paths extending from the line pattern to the respective holes,
wherein the line pattern and the paths disposed on one surface of the body are exposed, and
wherein a non-conductive region formed of an insulating material is disposed between the paths.

2. The motor of claim 1, wherein the busbar includes a busbar holder formed of a synthetic resin material and the terminal formed of a metal material.

3. The motor of claim 2, wherein the plurality of paths are formed to have the same size.

4. The motor of claim 1, wherein a thermal conductivity of the non-conductive region is lower than a thermal conductivity of the paths.

5. A motor comprising:
a stator;
a rotor disposed inside the stator;
a shaft coupled to the rotor;
busbar disposed on the stator;
a substrate in which a plurality of holes are formed and having end portions of terminals of the busbar disposed therein, respectively; and
a soldering member disposed in each hole to electrically connect each terminal and the substrate,
wherein the substrate includes a first substrate and a second substrate,
wherein the first substrate includes a first body in which a first hole is formed, a first line pattern formed around and spaced apart from the first hole, and a plurality of first paths extending from the first line pattern to the first hole, and
wherein the second substrate includes a second body in which a second hole is formed, a second line pattern disposed around and spaced apart from the second hole, and a plurality of second paths extending from the second line pattern to the second hole.

6. The motor of claim 5, wherein the first substrate and the second substrate are alternately stacked to form the substrate.

7. The motor of claim 6, wherein the first paths disposed on the first substrate and the second paths disposed on the second substrate are alternately disposed.

8. The motor of claim 6, wherein the first paths disposed on the first substrate and the second paths disposed on the second substrate do not overlap in a stacking direction.

9. The motor of claim 6, wherein the number of the first paths disposed on the first substrate and the number of the second paths disposed on the second substrate are the same.

10. The motor of claim 9, wherein:
the first hole is formed in a polygonal shape; and
the number of first paths disposed to correspond to each surface of the first hole is an odd number.

11. The motor of claim 10, wherein a total number of the first paths is two times the number of the surfaces.

12. The motor of claim 9, wherein:
the second hole and the first hole are formed in a same shape; and
the number of the second paths disposed to correspond to each surface of the second hole is an even number.

13. The motor of claim 12, wherein a total number of the second paths is two times the number of the surfaces.

14. The motor of claim 6, wherein:
the first substrate includes a first non-conductive region disposed between the first paths;
the second substrate includes a second non-conductive region disposed between the second paths; and
the first paths overlap the second non-conductive region in a stacking direction.

15. The motor of claim 10, wherein:
the second hole and the first hole are formed in a same shape; and
the number of the second paths disposed to correspond to each surface of the second hole is an even number.

16. The motor of claim 15, wherein a total number of the second paths is two times the number of the surfaces.
